(19) United States
(12) Patent Application Publication
(10) Pub. No.: US 2018/0163926 A1
(43) Pub. Date: Jun. 14, 2018

(54) HIGH PRESSURE TANK, METHOD OF PRODUCING THE HIGH PRESSURE TANK, AND APPARATUS FOR PRODUCING THE HIGH PRESSURE TANK

(71) Applicant: HONDA MOTOR CO., LTD., Tokyo (JP)

(72) Inventors: Koei Fujiki, Wako-shi (JP); Kenta Umetsu, Wako-shi (JP); Kazufusa Miyajima, Wako-shi (JP)

(21) Appl. No.: 15/835,581

(22) Filed: Dec. 8, 2017

(30) Foreign Application Priority Data
Dec. 13, 2016 (JP) 2016-241527

(51) Int. Cl. F17C 1/16; F17C 13/00

(52) U.S. Cl. CPC F17C 1/16; F17C 13/002; F17C 2201/0109; F17C 2203/012; F17C 2203/0629; F17C 2203/066; F17C 2260/011; F17C 2203/068; F17C 2209/2154; F17C 2209/232; F17C 2221/012; F17C 2270/0168; F17C 2209/2127; F17C 2203/0668

(57) ABSTRACT

A high pressure tank production apparatus includes a feeder for feeding reinforced fibers wound around a resin liner and a near infrared ray radiation unit inserted into the resin liner to radiate near infrared rays. The reinforced fibers wound around the resin liner absorb near infrared rays radiated from the radiate near infrared ray radiation unit by a near infrared absorber contained in the reinforced fibers. As a result, an outer layer made of fiber reinforced resin is formed to cover the resin liner.

### CROSS-REFERENCE TO RELATED APPLICATION

This application is based upon and claims the benefit of priority from Japanese Patent Application No. 2016-241527 filed on Dec. 13, 2016, the contents of which are incorporated herein by reference.

### BACKGROUND OF THE INVENTION

### Field of the Invention

The present invention relates to a high pressure tank including an inner layer and an outer layer made of fiber reinforced resin and covering the inner layer. Further, the present invention relates to a method of producing the high pressure tank and a production apparatus for obtaining the high pressure tank.

### Description of the Related Art

For example, the high pressure tank is provided in a fuel cell system, and stores a hydrogen gas to be supplied to the anode. The high pressure tank of this type includes an inner layer in the form of a resin liner made of thermoplastic resin having hydrogen barrier property, etc., and an outer layer surrounding the inner layer (resin liner). In most cases, the outer layer is made of fiber reinforced resin (FRP: fiber reinforced plastics) formed by impregnating reinforced fibers with resin base material. In general, carbon fibers are adopted as the reinforced fibers.

For example, the high pressure tank having this structure is obtained by winding reinforced fibers impregnated with a resin solution as resin base material around the resin liner, and thereafter, hardening the resin solution by heating to form the fiber reinforced resin. The above winding is also referred as filament winding.

In recent years, it has been proposed to heat the resin liner from the hollow space inside the resin liner, while performing filament winding. For example, Japanese Laid-Open Patent Publication No. 2011-136491 describes a technique where a heater inserted in the hollow space in a resin liner is used to harden, from a side closer to an inner layer toward a distal side, a resin solution contained in resin fibers externally wound around the resin liner.

Further, Japanese Laid-Patent Publication No. 2014-124901 discloses a technique where reinforced resin impregnated with thermoplastic resin having ultraviolet curable property is wound around a resin liner, and an ultraviolet light is radiated from an ultraviolet radiation part inserted into the hollow space in the resin liner, and reinforced resin wound around the resin liner is heated from the outside of the resin liner.

### SUMMARY OF THE INVENTION

According to the description of Japanese Laid-Open Patent Publication No. 2011-136491, in the case of heating the resin solution outside the resin liner using a heater provided inside the resin liner, the temperature of the resin liner becomes higher than the temperatures of the reinforced fibers and the resin solution provided outside the resin layer. Therefore, there is a concern that the resin liner is deformed thermally. In particular, in the case where the resin liner is made of polyethylene resin, since the heat resistant temperature is about 100° C. to 120° C., it is necessary to suppress the temperature inside the resin liner up to about 80° C. so as to avoid thermal deformation of the resin liner.

Therefore, it is necessary to select resin which can be hardened at 80° C., as the resin for obtaining the resin solution. That is, the resin has limited choices. Further, such resin, in general, has a short usable life (pot life) starting when two solutions are mixed and ending when the resin has been cured, and it is not possible to preserve the resin easily for long time. For this reason, it is necessary to mix the resin in the amount required for impregnation each time, and such operation is laborious. Further, though the usable life of this type of resin is short, it takes long time until the resin is hardened to such a degree that it can be used as an outer layer of the high pressure tank. Therefore, it is difficult to improve the productivity of the high pressure tank.

Further, in general, the resin liner is made of high density polyethylene. The high density polyethylene has low ultraviolet transmittance. Therefore, as described in Japanese Laid-Open Patent Publication No. 2014-124901, in order to cure the resin solution outside the resin liner by the ultraviolet light radiated from the inside of the resin liner, it is required to add a large quantity of ultraviolet curing agent to the resin solution. The resin base material obtained from such resin solution needs to be stored and/or used in an environment where the resin base material cannot be exposed to the ultraviolet light easily. Since the sunlight includes ultraviolet light, for example, it is considered to cover the high pressure tank with a light shielding sheet. Therefore, this case may have disadvantages in terms of increase in the capital investment and/or the management cost.

A main object of the present invention is to provide a high pressure tank which makes it possible to improve the productivity.

Another object of the present invention is to provide a high pressure tank which makes it possible to reduce the management cost.

Still another object of the present invention is to provide a method of producing the above described high pressure tank.

Still another object of the present invention is to provide a high pressure tank production apparatus which makes it possible to reduce the capital investment.

According to an embodiment of the present invention, a high pressure tank including an inner layer formed of a resin liner and an outer layer made of fiber reinforced resin is provided. The outer layer contains a near infrared absorber.

As described below, using the near infrared absorber, it is possible to form the outer layer efficiently while avoiding the occurrence of thermal deformation of the inner layer. Therefore, in the high pressure tank, it is becomes possible to select the resin base material of the fiber reinforced resin of the outer layer more freely. Further, in the high pressure tank, unlike the conventional technique where the ultraviolet curing agent is added, it is not necessary to shield the ultraviolet light. That is, there is no need to take counter measures, such as covering by the light-shielding sheet, storage and/or use of the high pressure tank in an environment unexposed to ultraviolet light. Therefore, it is possible to reduce the capital investment and/or management cost.

Preferably, the near infrared absorber is dispersed uniformly in the outer layer, and present between reinforced fibers. It is because, in this case, since the resin base material in the outer layer is hardened uniformly, the outer layer is reinforced evenly.

Preferably, the material of the inner layer is at least any of high density polyethylene resin, nylon resin, and EVOH (ethylene-vinyl alcohol copolymer) resin. In particular, since the high density polyethylene resin can be machined easily, it is possible to obtain the inner layer easily. Further, the high density polyethylene resin is excellent in terms of the durability and the pressure resistance. Further, the polyethylene resin has high near infrared transmittance. Therefore, even if irradiated with the near infrared rays, the temperature cannot be increased easily, and thus, thermal deformation does not occur easily. Therefore, the polyethylene resin can be used suitably.

According to another embodiment of the present invention, a method of producing a high pressure tank by providing an outer layer made of fiber reinforced resin for an inner layer in the form of a resin liner to obtain the high pressure tank is provided. The method includes the steps of immersing reinforced fibers into a resin solution after adding near infrared absorber to the resin solution, winding the reinforced fibers impregnated with resin around the resin liner, and curing the resin solution by heating as a result of radiation of near infrared rays to the resin solution.

The winding step and the curing step are performed at the same time.

In the present invention, the near infrared rays are used for heating the resin solution. That is, the near infrared absorber added to the resin solution absorbs the near infrared ray to generate heat. As a result, the resin solution is heated, and cured. Therefore, only the resin solution is heated efficiently and can be used as the resin base material. Therefore, it becomes easy to avoid the occurrence of thermal deformation of the resin liner as the inner layer. Further, since the ultraviolet curing agent is not contained in the high pressure tank thus obtained, it becomes unnecessary to shield the ultraviolet light.

Further, since the winding step (winding of the reinforced fibers around the resin liner) and the curing step (formation of the outer layer) are performed at the same time, it is possible to produce the high pressure tank efficiently.

For example, the near infrared ray radiation unit for radiating near infrared rays can be inserted into the resin liner. In this case, since there is no need to provide the near infrared ray radiation unit surrounding the resin liner, it is possible to simplify, and reduce the size of the near infrared ray radiation unit.

Further, preferably, the temperature of the fiber reinforced resin formed outside the resin liner is measured by a non-contact type thermometer. In this case, it is possible to avoid formation of contract traces of the thermometer on the fiber reinforced resin. Therefore, in this respect, the resulting high pressure tank is aesthetically advantageous.

Further, preferably, feedback control is implemented based on a result of the temperature measurement to control a quantity of the near infrared rays irradiated from the near infrared ray radiation unit. As a result, the occurrence of thermal deformation of the resin liner as the inner layer is avoided more effectively.

A tow-prepreg may be obtained by temporarily hardening the resin solution contained in the reinforced fibers. In the winding step, this tow-prepreg should be wound around the resin liner. In this case, dispersion of the resin solution and/or adhesion of the resin solution to feeding means, etc. described later are avoided.

According to still another embodiment of the present invention, a high pressure tank production apparatus for obtaining a high pressure tank including an inner layer in the form of a resin liner and an outer layer made of fiber reinforced resin is provided. The high pressure tank production apparatus includes a feeder configured to feed reinforced fibers impregnated with a resin solution, a holder configured to hold the resin liner, a rotation driving unit configured to rotate the resin liner, and a near infrared ray radiation unit configured to radiate near infrared rays for heating the resin solution contained in the reinforced fibers wound around the resin liner.

By adopting the above structure, it is possible to efficiently form the outer layer while avoiding the occurrence of thermal deformation in the inner layer. That is, it is possible to improve the productivity of the high pressure tank.

Preferably, the near infrared ray radiation unit is inserted into the resin liner. It is because, the near infrared ray radiation unit can be simplified, and the size of the near infrared ray radiation unit is reduced in comparison with the case where the near infrared ray radiation unit surrounds the resin liner.

Further, it is preferable to provide a non-contact type thermometer configured to measure the temperature of the fiber reinforced resin formed outside the resin liner. By controlling (by implementing feedback control) the quantity of near infrared rays radiated from the near infrared ray radiation unit based on the result of measurement by this non-contact type thermometer, it is possible to avoid the occurrence of heat deformation of the resin liner more effectively. Further, it is possible to prevent formation of contact traces of the thermometer on the fiber reinforced resin (outer layer).

The feeding means may be configured to feed the reinforced fibers as a tow-prepreg formed by temporarily hardening the resin solution contained in the reinforced fibers. It is because scattering of the resin solution and/or adhesion of the resin solution to the feeding means can be avoided.

As described above, in the present invention, the high pressure tank is obtained by forming the outer layer covering the inner layer as a layer containing the near-infrared ray absorbing material. Therefore, the near infrared absorber is added to the resin solution for obtaining the fiber reinforced resin to be the outer layer.

Thus, the near infrared absorber in the resin solution absorbs the near infrared rays efficiently to generate heat. As a result, the resin solution is cured by heating to form the resin base material. Therefore, it is possible to efficiently form the outer layer made of fiber reinforced resin while avoiding the occurrence of thermal deformation of the resin liner as the inner layer. Thus, it is possible to improve the productivity of the high pressure tank.

In this case, unlike the conventional case where the resin solution contains the ultraviolet curing agent, there is no need to shield the ultraviolet light, and/or to store and/or use the high pressure tank in an environment unexposed to the ultraviolet light. Therefore, it is possible to achieve reduction in the capital investment and the management cost.

The above and other objects, features and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is an overall cross sectional view schematically showing a high pressure tank according to an embodiment of the present invention in a longitudinal direction of the high pressure tank;

FIG. 2 is a side view schematically showing main components of a high pressure tank production apparatus according to an embodiment of the present invention;

FIG. 3 is a graph showing an absorption curve of epoxy resin containing near infrared absorber and an absorption curve of epoxy resin which does not contain any near infrared absorber;

FIG. 4 is graph of a profile in the depth direction in the case where a fiber reinforced resin layer (outer layer) is formed from a tow-prepreg which does not contain any near infrared absorber, on an inner layer in the form of a resin liner, showing the change in the temperature from an inner surface of the inner layer where a near infrared ray has entered, to the outer surface of the fiber reinforced resin layer,

FIG. 5 is graph of a profile in the depth direction in the case where a fiber reinforced resin layer (outer layer) is formed from a tow-prepreg containing near infrared absorber, on an inner layer in the form of a resin liner, showing the change in the temperature from an inner surface of the inner layer where a near infrared ray has entered, to the outer surface of the fiber reinforced resin layer.

### DESCRIPTION OF THE PREFERRED EMBODIMENTS

Hereinafter, a preferred embodiment of a high pressure tank according to the present invention will be described in detail with reference to the accompanying drawings, in relation to a method of producing the high pressure tank and a high pressure tank production apparatus for carrying out the production method.

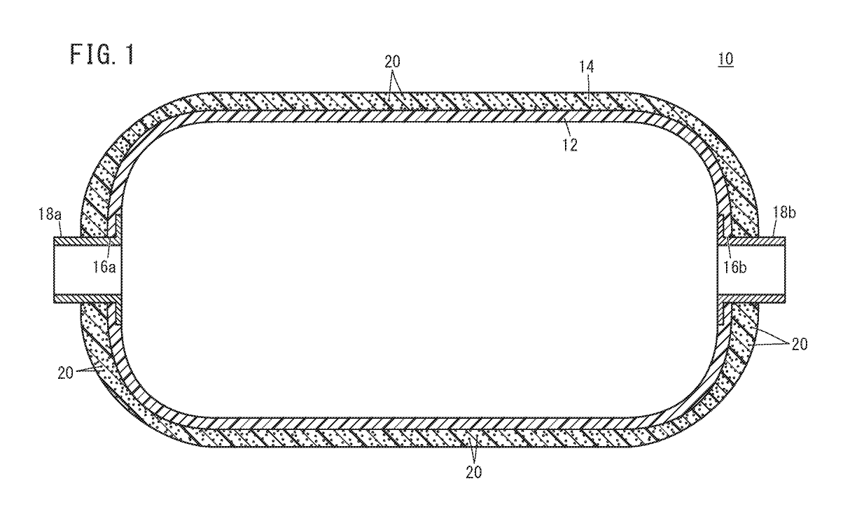

FIG. 1 is an overall cross sectional view schematically showing a high pressure tank 10 according to an embodiment of the present invention. For example, the high pressure tank 10 is mounted in an automobile vehicle body together with a fuel cell, and a hydrogen gas which is to be supplied to an anode of the fuel cell is filled in the high pressure tank 10 at high pressure.

The high pressure tank 10 includes an inner layer 12, and an outer layer 14 covering the inner layer 12. In this case, the inner layer 12 is made up of a resin liner made of high density polyethylene (HDPE) resin having hydrogen barrier property. The HDPE resin is thermoplastic resin. Since the HDPE resin is inexpensive, and can be machined easily, it is possible to produce the inner layer 12 easily at low cost. Further, since the HDPE resin has excellent strength and rigidity, the inner layer 12 has the sufficient pressure resistance.

Openings 16a, 16b are formed at both ends of the inner layer 12. Caps 18a, 18b are provided for at least one of the openings 16a, 16b. Pipes (not shown) for supplying the hydrogen gas to an anode, or replenishing the hydrogen from a hydrogen replenish source are connected to the caps 18a, 18b. Front ends of the caps 18a, 18b are exposed from the outer layer 14.

The outer layer 14 is made of fiber reinforced resin (FRP: fiber reinforced plastics) formed by impregnating reinforced fibers with resin base material. Further, the outer layer 14 contains near infrared absorber 20 such as near infrared ray absorbing dye. This near infrared absorber 20 is dispersed uniformly in the outer layer 14, and present between the reinforced fibers.

Next, a production method and a production apparatus for obtaining the high pressure tank 10 will be described.

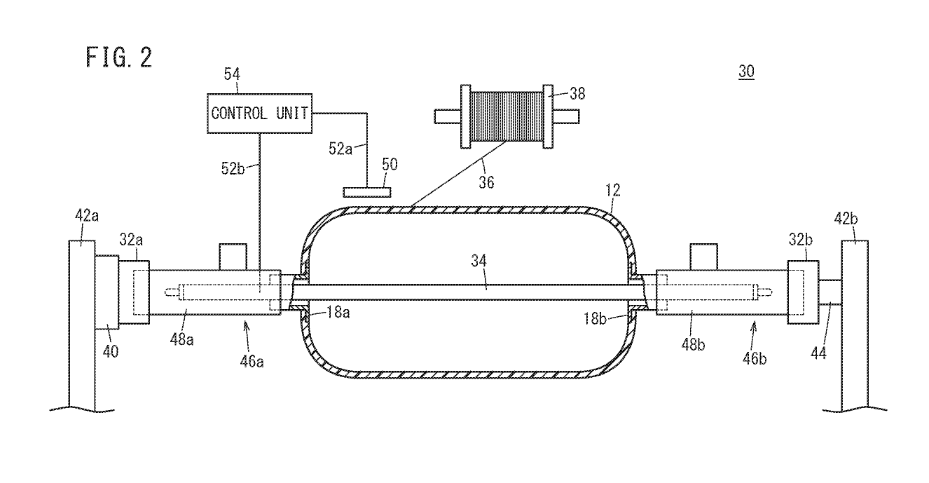

FIG. 2 is a side view schematically showing main components of a high pressure tank production apparatus 30 according to an embodiment of the present invention. The high pressure tank production apparatus 30 comprises a rotatable holder shafts 32a, 32b (holding means) in the form of a hollow body, a halogen lamp heater 34 (near infrared radiation means) supported by these holder shafts 32a, 32b and a feeder 38 (feeding means) for feeding a tow-prepreg 36 which is a reinforced fiber impregnated with resin solution.

The holder shaft 32a is supported by a support column 42a through a rotation driving unit 40 (rotation drive means). That is, the holder shaft 32a can be rotated under operation of the rotation driving unit 40. The holder shaft 32b is rotatably supported by the support column 42b through a rotation support shaft 44. As described above, rotation of the holder shaft 32b is driven to rotate by rotation of the holder shaft 32a.

Alternatively, a first pulley may be provided for the holder shaft 32a. In this case, a rotation motor (rotation drive means) is provided in the vicinity of the first pulley. A second pulley is provided for the rotation shaft of the rotation motor. A timing belt is trained between the first pulley and the second pulley. In the structure, when the rotation motor is actuated, and the rotation shaft is rotated, the timing belt is rotated accordingly. As a result, the holder shaft 32a is rotated. Rotary joints 46a, 46b are interposed between the holder shafts 32a, 32b and the inner layer 12. A rotor 48a of the rotary joint 46a shown at the left end of FIG. 2 is inserted into the holder shaft 32a. A first stator (not shown) is accommodated in the left end. Further, the cap 18a is inserted into the right end. Likewise, the cap 18b is inserted into the left end of a rotor 48b of the rotary joint 46b. The right end is inserted into the holder shaft 32b. A second stator (not shown) is accommodated in the right end. Rotation of the first stator and rotation of the second stator are not driven by rotation of the rotor 48a and rotation of the rotor 48b.

The halogen lamp heater 34 is supported by the first stator and the second stator, and thus, the halogen lamp heater 34 is supported indirectly by the holder shafts 32a, 32b. Since the first stator and the second stator are not rotated, rotation of the halogen lamp heater 34 is not driven to rotate as well.

In the embodiment of the present invention, the tow-prepreg 36 is wound around the feeder 38. The tow-prepreg 36 is formed by impregnating reinforced fibers with resin solution of thermoplastic resin beforehand. In this case, there is an advantage that no dip tank is required between the feeder 38 and the inner layer 12 (resin liner), for storing resin solution used for impregnation of the reinforced fibers. The resin solution contained in the reinforced fibers is hardened temporarily beforehand to such a degree that the resin solution loses its fluidity. Therefore, adhesion of the resin solution to the feeder 38, etc. wound around by the tow-prepreg 36 is prevented.

The near infrared absorber 20 has been added to the resin solution beforehand. Therefore, in the reinforced fibers impregnated with the resin solution, the near infrared absorber 20 penetrates between the reinforced fibers, and is dispersed uniformly in the reinforced fibers.

In order to change the position where the tow-prepreg 36 is wound relative to the inner layer 12, the feeder 38 can be displaced as necessary in the longitudinal direction of the inner layer 12. Alternatively, the feeder 38 may be positioned and fixed, and a known delivery AI may be provided between the feeder 38 and the inner layer 12.

Further, the high pressure tank production apparatus 30 includes a radiation thermometer 50 which is a non-contact type thermometer, and a control unit 54 electrically connected to the radiation thermometer 50 and the halogen lamp heater 34 through signal lines 52a, 52b. The radiation thermometer 50 is provided in the vicinity of the inner layer 12, and measures the temperature of the fiber reinforced resin (outer layer 14) wrapped around the inner layer 12. The result of this measurement is transmitted as an information signal, to the control unit 54 through the signal line 52a. Further, the control unit 54 controls the output of the halogen lamp heater 34 by a control signal transmitted through the signal line 52b.

The high pressure tank production apparatus 30 according to the embodiment of the present invention basically has the above structure. Next, operation and advantage will be described in relation to a method of producing the high pressure tank 10 according to the embodiment of the present invention.

Firstly, for obtaining the high pressure tank 10, a resin liner as the inner layer 12 is produced by blow molding, etc. using molten material of HDPE resin. Next, the resin liner (inner layer 12) is held by the holder shafts 32a, 32b of the high pressure tank production apparatus 30. Specifically, the caps 18a, 18b are inserted into the hollow spaces inside the rotors 48a, 48b of the rotary joints 46a, 46b, respectively, and the rotors 48a, 48b are inserted into the hollow spaces inside the holder shafts 32a, 32b. At this time, the halogen lamp heater 34 is inserted into the inner layer 12 from the caps 18a, 18b, and ends of the halogen lamp heater 34 are supported by the first stator and the second stator of the rotary joints 46a, 46b.

In the meanwhile, for example, epoxy resin is melted to prepare resin solution, and the resin solution is stored in the dip tank. Further, the near infrared absorber 20 for absorbing near infrared rays having the wavelength length of about 400 to 1000 nm is added to the resin solution. Preferred examples of the near infrared absorber 20 include near infrared dyes such as cyanine compounds, phthalocyanine compounds, dithiol metal complex, naphthoquinone compounds, and carbon black for coloring. It is a matter of course that near infrared absorber other than the dyes may be used. Further, the resin for preparing the resin solution may be polyester resin, phenol resin, polyamide resin, etc.

Preferably, the near infrared absorber 20 is added to the resin solution at the ratio in a range of 0.5 wt % to 20 wt %. If the ratio is less than 0.5 wt %, the effect of absorbing the near infrared rays in a curing step described later becomes insufficient. Further, since the near infrared ray absorbing capability is saturated at about 20 wt %, it is not economical to add the near infrared absorber in the quantity exceeding 20 wt %.

It is preferable to add a dispersant to the resin solution. Alternatively, the resin solution may be stirred at the time of adding the near infrared absorber 20 or thereafter. It is a matter of course that the dispersant may be added, and additionally, the resin solution may be stirred. In this manner, it is possible to disperse the near infrared absorber 20 in the resin solution uniformly.

In this case, it is not necessary to add any material other than the near infrared absorber 20 and/or the dispersant. Therefore, the usable life of the resin solution is not affected. Further, since it is possible to prepare the resin solution using the existing facility, additional capital investment is not required.

Next, an impregnation step is performed. Specifically, the reinforced fibers such as carbon fibers are impregnated with the resin solution containing the near infrared absorber 20 dispersed as described above. As a result, the resin solution permeates into every space between the reinforced fibers. That is, the reinforced fibers are impregnated with the resin solution. Thereafter, the tow-prepreg 36 is obtained by drying and temporarily hardening the resin solution to such a degree that the resin solution loses its fluidity.

Since the near infrared absorber 20 is dispersed into the resin solution uniformly, the near infrared absorber 20 is dispersed uniformly in the tow-prepreg 36. Further, since the resin solution permeates in the spaces between the reinforced fibers, the near infrared absorber 20 is present between the reinforced fibers.

Next, the winding step and the curing step are performed at the same time. Specifically, after the tow-prepreg 36 is wound around the feeder 38, one end of the tow-prepreg 36 is drawn from the feeder 38, and the tow-prepreg 36 is wound around the resin liner (inner layer 12) held by the holder shafts 32a, 32b of the high pressure tank production apparatus 30. Thereafter, the rotation driving unit 40 is actuated to rotate to the holder shaft 32a. Accordingly, the rotor 48a of the rotary joint 46a, the inner layer 12, the rotor 48b of the rotary joint 46b, the holder shaft 32b, and the rotation support shaft 44 are driven to rotate together as well. It should be noted that the first stator and the second stator of the rotary joints 46a, 46b and the halogen lamp heater 34 supported by the first stator and the second stator are not rotated.

The halogen lamp heater 34 is actuated at the same time as, or before and/or after starting rotation of the holder shaft 32a. As a result, the near infrared ray is radiated from the halogen lamp heater 34 toward the inner surface of the inner layer 12.

The feeder 38 is displaced to move back and forth in the longitudinal direction of the inner layer 12. As a result, the winding position of the tow-prepreg 36 is changed. Therefore, the entire inner layer 12 is covered with the tow-prepreg 36. In the meanwhile, the near infrared rays are radiated continuously inside the inner layer 12. Therefore, during filament winding, the near infrared rays enter from the inner surface of the inner layer 12.

In the embodiment of the present invention, the resin liner as the inner layer 12 is made of HDPE resin. The polyethylene resin is a good near infrared ray transmitter. Therefore, the near infrared rays which have entered from the inner surface of the inner layer 12 easily reach the tow-prepreg 36 closer to the outer surface. The near infrared ray which reached the tow-prepreg 36 is absorbed by the near infrared absorber 20 in the resin solution.

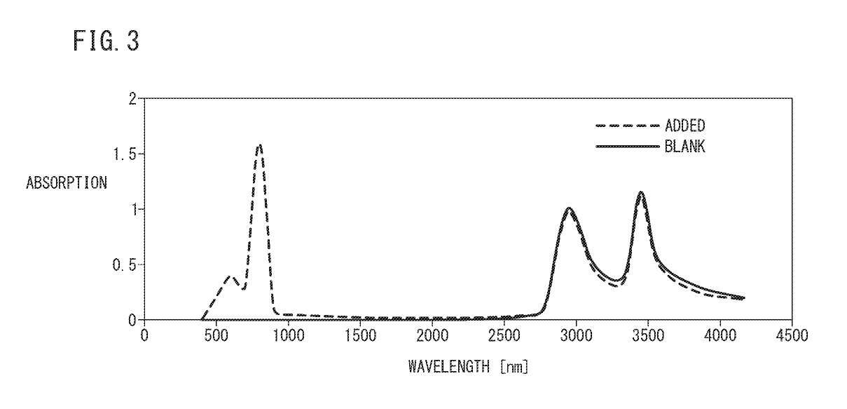

FIG. 3 shows an absorption curve of epoxy resin containing near infrared absorber 20 and also shows an absorption curve of epoxy resin which does not contain any near infrared absorber 20. In FIG. 3, the epoxy resin containing the near infrared absorber 20 is denotes as “ADDED”, and the absorption curve of the epoxy resin is denoted by a broken line. Further, the epoxy resin which does not contain any near infrared absorber 20 is denotes as “BLANK”, and the absorption curve of the epoxy resin is denoted by a solid line. By comparing the broken line and the solid line, it can be clearly understood that the near infrared ray, in particular, around 400 to 900 nm can be absorbed easily as a result of the near infrared absorber 20 added.

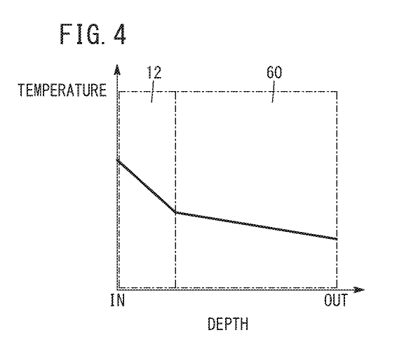

Further, FIG. 4 is a graph of a profile in the depth direction in the case where a fiber reinforced resin layer 60 is formed from a tow-prepreg which does not contain any near infrared absorber 20, showing the change in the temperature from an inner surface of the inner layer 12 where a near infrared ray has entered, to the outer surface of the fiber reinforced resin layer 60. As can be seen from FIG. 4, in the resin liner as the inner layer 12, the temperature is decreased from the inner surface toward the outer surface, and likewise, in the fiber reinforced resin layer 60, the temperature is decreased from the inner surface to the outer surface.

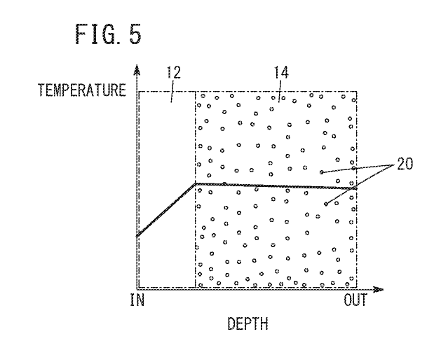

In contrast, in the case where the outer layer 14 is formed from the tow-prepreg 36 containing the near infrared absorber 20, as shown in FIG. 5, in the inner layer 12 where the near infrared ray entered, the temperature is slightly increased from the inner surface to the outer surface. In the outer layer 14 (or tow-prepreg 36), the temperature is kept substantially constant. It is because the near infrared absorber 20 in the outer layer 14 absorbs the near infrared rays which have been transmitted through the inner layer 12, to generate heat, and the heat in the outer layer 14 is transmitted to the inner layer 12.

As described above, the near infrared ray radiated from the halogen lamp heater 34 is absorbed efficiently by the near infrared absorber 20 in the resin solution. Therefore, the resin solution is heated efficiently, and cured in a short period of time. That is, the resin base material is formed from the resin solution, being accompanied by that the outer layer 14 is made of the fiber reinforced resin. As described above, in the embodiment of the present invention, since the winding step (filament winding) and the curing step (formation of the outer layer 14) are performed at the same time, and moreover, the time required for curing the resin solution is shortened, it is possible to obtain the high pressure tank 10 efficiently. Stated otherwise, it is possible to improve the productivity of the high pressure tank 10.

Further, even if the near infrared rays enter the inner layer 12, the temperature of the inner layer 12 is not increased significantly (see FIG. 5). It is because the near infrared ray transmits through the inner layer 12. Therefore, it is possible to avoid thermal deformation of the inner layer 12. Thus, the resin for obtaining the resin solution can be selected from various resins without being limited to the resin which can be hardened at 80° C. That is, it becomes possible to select the resin base material more freely.

Further, since the near infrared absorber 20 is dispersed uniformly in the tow-prepreg 36, the near infrared ray is absorbed equally. Therefore, the resin solution on the inner layer 12 is hardened equally. The outer layer 14 obtained in this manner is reinforced evenly.

The temperature of the outer layer 14 is measured by the radiation thermometer 50 facing the outer layer 14 at a position slightly spaced from the outer layer 14. Since there is no need to bring the radiation thermometer 50 into contact with the outer layer 14, it is possible to prevent contact traces such as a recess from being formed on the outer layer 14.

The temperature measured by the radiation thermometer 50 is transmitted to the control unit 54 as an information signal through the signal line 52a. When the control unit 54 receives this information signal, the control unit 54 transmits a control signal to the halogen lamp heater 34 through the signal line 52b. Therefore, the output of the halogen lamp heater 34 is controlled in correspondence with the measurement temperature, i.e., the temperature of the outer layer 14. That is, in the case where the temperature of the outer layer 14 is excessively high, the output of the halogen lamp heater 34 is reduced. Conversely, in the case where the temperature of the outer layer 14 is excessively low, the output of the halogen lamp heater 34 is increased.

That is, feedback control is implemented, and the quantity of the near infrared ray radiation of the halogen lamp heater 34 is changed. Thus, the quantity of the heat generated in the outer layer 14 is changed. Also for this reason, thermal deformation of the inner layer 12 is avoided.

After the outer layer 14 is formed, as necessary, the outer layer 14 is further heated. This heating may be performed by the halogen lamp heater 34. Alternatively, this heating may be performed by heating means such as a heater provided outside the outer layer 14 additionally.

In this manner, the high pressure tank 10 is obtained. At the time of using the high pressure tank 10, unlike the conventional technique where the ultraviolet curing agent is added, it is not necessary to shield the ultraviolet light. That is, there is no need to take counter measures, such as use of a light shielding sheet as a cover, storage and/or use of the high pressure tank 10 in an environment unexposed to the ultraviolet light. Accordingly, it is possible to achieve reduction in the capital investment and/or the management cost.

The present invention is not limited specifically to the above described embodiment. Various modifications can be made without deviating the gist of the present invention.

For example, the impregnation step may be performed by immersing the reinforced fibers fed from the feeder 38 in the resin solution. In this case, the dip tank is provided between the feeder 38 and the inner layer 12 held by the holder shafts 32a, 32b. Then, the reinforced fibers impregnated with the resin solution should be wound around the inner layer 12.

Further, the inner layer 12 may not be made of high density polyethylene resin. The inner layer 12 may be made of at least one of nylon resin and EVOH resin.

What is claimed is:

1. A high pressure tank comprising:
an inner layer formed of a resin liner; and
an outer layer made of fiber reinforced resin,
wherein the outer layer contains a near infrared absorber.

2. The high pressure tank according to claim 1, wherein the near infrared absorber is dispersed uniformly in the outer layer, and present between reinforced fibers.

3. The high pressure tank according to claim 1, wherein the inner layer is made of near infrared transmitting resin.

4. The high pressure tank according to claim 1, wherein the inner layer is made of at least one of high density polyethylene resin, nylon resin, and ethylene-vinyl alcohol copolymer resin.

5. A method of producing a high pressure tank by providing an outer layer made of fiber reinforced resin for an inner layer formed of a resin liner to obtain the high pressure tank, the method comprising the steps of:
impregnating reinforced fibers with a resin solution after adding a near infrared absorber to the resin solution;
winding the reinforced fibers impregnated with resin around the resin liner; and
curing the resin solution by heating as a result of radiation of near infrared rays to the resin solution,
wherein the winding step and the curing step are performed simultaneously.

6. The method of producing the high pressure tank according to claim 5, wherein the heating is performed by inserting, into the resin liner, a near infrared ray radiation unit configured to radiate near infrared rays.

7. The method of producing the high pressure tank according to claim 5, wherein a temperature of the fiber reinforced resin formed outside the resin liner is measured by a non-contact type thermometer; and feed back control is implemented based on a result of the measurement to control a quantity of the near infrared ray radiated by the near infrared ray radiation unit.

8. The method of producing the high pressure tank according to claim 5, wherein a tow-prepreg is obtained by temporarily hardening the resin solution contained in the reinforced fibers, and in the winding step, the tow-prepreg is wound around the resin liner.

9. The method of producing the high pressure tank according to claim 5, wherein the resin liner is made of near infrared transmitting resin.

10. A high pressure tank production apparatus for obtaining a high pressure tank comprising an inner layer formed of a resin liner and an outer layer made of fiber reinforced resin, the high pressure tank production apparatus comprising:
a feeder configured to feed reinforced fibers impregnated with a resin solution;
a holder configured to hold the resin liner;
a rotation driving unit configured to rotate the resin liner; and
a near infrared ray radiation unit configured to radiate near infrared rays for heating the resin solution contained in the reinforced fibers wound around the resin liner.

11. The high pressure tank production apparatus according to claim 10, wherein the near infrared ray radiation unit is inserted into the resin liner.

12. The high pressure tank production apparatus according to claim 10, comprising a non-contact type thermometer configured to measure a temperature of the fiber reinforced resin formed outside the resin liner.

13. The high pressure tank production apparatus according to claim 10, wherein the feeder is configured to feed the reinforced fibers as a tow-prepreg formed by temporarily hardening the resin solution contained in the reinforced fibers.
